(19) United States
(12) Patent Application Publication
(10) Pub. No.: US 2026/0126063 A1
(43) Pub. Date: May 7, 2026

(54) FIXING DEVICE FOR PERSONAL MOBILITY

(71) Applicants: Hyundai Motor Company, Seoul (KR); Kia Corporation, Seoul (KR); Yong San Co., Ltd., Ulsan (KR)

(72) Inventors: Jin Ho HWANG, Hwaseong-si (KR); Ji Ah KIM, Hwaseong-Si (KR); Ji Seob PARK, Hwaseong-Si (KR); Sang Heon LEE, Hwaseong-Si (KR); Kyung Jae PARK, Asan-Si (KR); Choon Taik KIM, Asan-Si (KR)

(73) Assignees: Hyundai Motor Company, Seoul (KR); Kia Corporation, Seoul (KR); Yong San Co., Ltd., Ulsan (KR)

(21) Appl. No.: 19/193,801

(22) Filed: Apr. 29, 2025

(30) Foreign Application Priority Data
Nov. 6, 2024 (KR) 10-2024-0156568

(51) Int. Cl. F16B 1/02

(52) U.S. Cl. CPC F16B 1/02; F16B 2200/83

(57) ABSTRACT

A fixing apparatus for personal mobilities that secure small mobilities, includes wheelchairs, to large mobilities, including vehicles, with strong fixing force, and ensures convenience of use by making it easy to fix or unlock small mobilities.

### CROSS REFERENCE TO RELATED APPLICATIONS

The present application claims priority to Korean Patent Application No. 10-2024-0156568, filed Nov. 6, 2024, the entire contents of which is incorporated herein for all purposes by this reference.

### BACKGROUND OF THE PRESENT DISCLOSURE

### Field of the Present Disclosure

The present disclosure relates to a fixing device for personal mobilities, and more particularly, to a fixing device for personal mobilities that allows small mobilities, including wheelchairs, to be secured to large mobilities, including vehicles.

Description of Related art

In general, wheelchairs and electric wheelchairs are used as a means of transportation for people with impairments or the elderly who have difficulty of moving, and miniaturized electric mobilities are being developed as a convenient means of transportation in addition to the means of transportation for people with difficulty of moving.

Recently, as the welfare of the impaired has improved, wheelchairs or electric wheelchairs can board not only wheelchair accessible vehicles but also in general public transportation, thus providing convenience to wheelchair or electric wheelchair users.

Against the present backdrop, large transport vehicles that can accommodate wheelchairs or electric wheelchairs are provided with a fixing device to keep a wheelchair or electric wheelchair in a locked state to prevent the wheelchair or electric wheelchair from moving.

However, because such fixing devices secure the wheels of a wheelchair or electric wheelchair by holding (restraining) the wheels, the fixation efficiency for the wheelchair or electric wheelchair deteriorates, and when using a belt to secure a wheelchair or electric wheelchair, connecting the belt is inconvenient, and the complicated structure reduces convenience of use.

Securing the wheels of a wheelchair or electric wheelchair by holding the wheels may reduce safety due to a decrease in fixation efficiency, which may result in a safety accident. If pressure is applied directly to a wheel, surrounding parts, including the wheel, may be damaged.

Moreover, when getting a wheelchair or electric wheelchair off a large transport vehicle, the process of unlocking a fixing device is also complicated.

The information included in this Background of the present disclosure is only for enhancement of understanding of the general background of the present disclosure and may not be taken as an acknowledgement or any form of suggestion that this information forms the prior art already known to a person skilled in the art.

### BRIEF SUMMARY

Various aspects of the present disclosure are directed to providing a fixing device for personal mobilities that secures small mobilities including wheelchairs to large mobilities including vehicles with strong fixing force, and ensures convenience of use by making it easy to fix or unlock small mobilities.

Objectives to be achieved by the present disclosure are not limited to the ones mentioned above, and other objectives not mentioned may be clearly understood by those skilled in the art from the description below.

To achieve the objectives of the present disclosure, there is provided a fixing device for personal mobilities, the device including: a connection module provided to an object requiring fixation; and a fixing module provided on a floor surface, into which a portion of the connection module is inserted, and including a first fixing means and a second fixing means for fixing the inserted connection module, wherein the first fixing means may be magnetically fixed to the connection module by generating a magnetic field and the second fixing means may come into contact with the inserted connection module to mechanically fix the connection module.

According to an exemplary embodiment of the present disclosure, the fixing module may include: a housing provided on the floor surface; and a fixing holder including a guide groove formed inward of the fixing holder at a top portion of the housing, and the connection module may include a fixing guide whose insertion direction is guided along the guide groove of the fixing holder.

According to an exemplary embodiment of the present disclosure, the guide groove of the fixing holder may have an area that gradually narrows inwardly from an entrance portion thereof where insertion of the fixing guide begins.

According to an exemplary embodiment of the present disclosure, the fixing holder may be formed so that an upper end portion of an entrance portion thereof where insertion of the fixing guide begins in the guide groove may be inclined downward.

According to an exemplary embodiment of the present disclosure, the connection module may include a fixing bracket for connection to the fixing guide, wherein the fixing bracket and the fixing guide may be connected to each other via a connection member while spaced apart, and the connection member may be elastically moved in a direction where the fixing bracket and the fixing guide face each other.

According to an exemplary embodiment of the present disclosure, the fixing holder may be formed with an upper portion thereof partially open, and when the fixing guide of the connection module is inserted into the guide groove of the fixing holder, the connection member may enter the open portion of the fixing holder, and the connection member may include an end portion coupled to the fixing bracket, may be provided to be movable in a vertical direction in the fixing guide, and may be elastically supported by an elastic body within the fixing guide.

According to an exemplary embodiment of the present disclosure, the fixing module may further include a driving portion provided in the housing and configured to generate rotation force, wherein as the first fixing means and the second fixing means are connected to the driving portion, magnetic fixation of the first fixing means or mechanical fixation of the second fixing means may be selectively switched.

According to an exemplary embodiment of the present disclosure, the first fixing means may include a pole portion, a first magnetic material, and a second magnetic material, wherein the pole portion may be provided inside the housing and be partially exposed to an upper side of the housing to contact with the fixing guide inserted into the fixing holder, and the first magnetic material may be connected to the driving portion and may rotate from the pole portion, whereas the second magnetic material may be spaced apart from the first magnetic material and fixed to the pole portion.

According to an exemplary embodiment of the present disclosure, the first magnetic material and the second magnetic material may include permanent magnets, and a direction of magnetic flow may change depending on a rotational position of the first magnetic material changed by the driving portion.

According to an exemplary embodiment of the present disclosure, the pole portion and the fixing guide may be made of magnetic material, and be magnetically joined by the first magnetic material and the second magnetic material.

According to an exemplary embodiment of the present disclosure, the second fixing means may include a fixing block slidably provided inside the housing, and coupled to the driving portion to be taken out through an upper side of the housing according to a position changed by the driving portion.

According to an exemplary embodiment of the present disclosure, the fixing block may be disposed to be taken out in an opposite direction of the insertion direction of the fixing guide with the fixing guide inserted into the fixing holder, limiting a departure of the fixing guide.

According to an exemplary embodiment of the present disclosure, the second fixing means may further include a cam portion, wherein the cam portion may include an inclined portion formed on a peripheral surface thereof and may be connected to the driving portion to rotate, and in a state where the fixing block is seated on the cam portion, the fixing block may be taken out of or put into the upper side of the housing by making a linear reciprocating movement in a vertical direction due to a rotation of the cam portion.

According to an exemplary embodiment of the present disclosure, the second fixing means may further include a support portion guiding the linear movement of the fixing block, wherein the support portion may be fixed inside the housing, may accommodate the fixing block therein, and may be provided to surround an outside of the fixing block.

According to an exemplary embodiment of the present disclosure, the driving portion may be provided with a shaft which is rotated by rotation force, wherein the shaft may be connected to the first fixing means and the second fixing means, so that when the shaft rotates, the magnetic fixation of the first fixing means and the mechanical fixation of the second fixing means may be performed simultaneously.

According to an exemplary embodiment of the present disclosure, the driving portion, the first fixing means, and the second fixing means may be disposed in series inside the housing, so that the shaft of the driving portion may be connected to the first fixing means and the second fixing means.

According to an exemplary embodiment of the present disclosure, a lower plate may be provided below the fixing module, and the lower plate and the housing may be connected via a guide pin, allowing the housing to move along an extension direction of the guide pin, wherein the guide pin may be provided with an elastic member that provides elastic support between the lower plate and the housing.

According to an exemplary embodiment of the present disclosure, the fixing holder may be provided with a sensor configured for measuring a distance from the fixing guide, and a controller which is configured to determine completion of insertion of the fixing guide according to a sensing value of the sensor may be further included.

According to a fixing device for personal mobilities of the present disclosure, it is possible to secure small mobilities, including wheelchairs, to large mobilities, including vehicles, with strong fixing force, and ensure convenience of use by making it easy to fix or unlock small mobilities.

The effects which may be obtained from the present disclosure are not limited to the effects mentioned above, and other effects not mentioned may be clearly understood by those skilled in the art from the description below.

The methods and apparatuses of the present disclosure have other features and advantages which will be apparent from or are set forth in more detail in the accompanying drawings, which are incorporated herein, and the following Detailed Description, which together serve to explain certain principles of the present disclosure.

### BRIEF DESCRIPTION OF THE DRAWINGS

FIG. 1 is a view showing a fixing device for personal mobilities according to an exemplary embodiment of the present disclosure.

FIG. 2 is a view showing a released state in the fixing device for personal mobilities according to an exemplary embodiment shown in FIG. 1.

FIG. 3 is a view showing a fixed state in the fixing device for personal mobilities according to an exemplary embodiment shown in FIG. 1.

FIG. 4 is a cross-sectional view taken along line A-A′ of the fixing device for personal mobilities according to an exemplary embodiment shown in FIG. 1.

FIG. 5 is a cross-sectional view taken along line B-B′ of the fixing device for personal mobilities according to an exemplary embodiment shown in FIG. 1.

FIG. 6 is a view showing the fastened state of a first fixing means in the fixing device for personal mobilities according to an exemplary embodiment of the present disclosure.

FIG. 7 is a view showing a state in which a fixing guide is inserted into a fixing holder in the fixing device for personal mobilities according to an exemplary embodiment shown in FIG. 1.

FIG. 8 is a view showing a housing and the fixing holder in the fixing device for personal mobilities according to an exemplary embodiment shown in FIG. 1.

FIG. 9 is a view showing the interior of the housing in the fixing device for personal mobilities according to an exemplary embodiment shown in FIG. 1.

FIG. 10 is a view showing the unfastened state of a second fixing means in the fixing device for personal mobilities according to an exemplary embodiment shown in FIG. 1.

FIG. 11 is a view showing the fastened state of the second fixing means in the fixing device for personal mobilities according to an exemplary embodiment shown in FIG. 1.

It may be understood that the appended drawings are not necessarily to scale, presenting a somewhat simplified representation of various features illustrative of the basic principles of the present disclosure. The specific design features of the present disclosure as included herein, including, for example, specific dimensions, orientations, locations, and shapes will be determined in part by the particularly intended application and use environment.

In the figures, reference numbers refer to the same or equivalent parts of the present disclosure throughout the several figures of the drawing.

### DETAILED DESCRIPTION

Reference will now be made in detail to various embodiments of the present disclosure(s), examples of which are illustrated in the accompanying drawings and described below. While the present disclosure(s) will be described in conjunction with exemplary embodiments of the present disclosure, it will be understood that the present description is not intended to limit the present disclosure(s) to those exemplary embodiments of the present disclosure. On the other hand, the present disclosure(s) is/are intended to cover not only the exemplary embodiments of the present disclosure, but also various alternatives, modifications, equivalents and other embodiments, which may be included within the spirit and scope of the present disclosure as defined by the appended claims.

In describing the exemplary embodiments included herein, if it is decided that the detailed description of known technologies related to the present disclosure makes the subject matter of the exemplary embodiments described herein unclear, the detailed description is omitted. Furthermore, the accompanying drawings are provided only for easy understanding of embodiments included in the specification, and the technical spirit included in the specification is not limited by the accompanying drawings, and all changes, equivalents, and replacements should be understood as being included in the spirit and scope of the present disclosure. The following disclosure is not intended to limit the present disclosure to the form included or to the particular field, and it is contemplated that various alternative aspects and modifications to the present disclosure are possible, whether explicitly stated or implied herein. A person skilled in the art to which the present disclosure pertains will recognize that the form and details of the present disclosure may change.

The present disclosure is described with reference to specific embodiments. However, as understood by those skilled in the art to which the present disclosure pertains, various aspects included herein may be modified or otherwise implemented in various other ways without departing from the spirit and scope of the present disclosure. Accordingly, the following description should be considered illustrative and is for teaching those skilled in the art how to make and use various embodiments. It will be understood that the forms of disclosure shown and described herein are to be taken as representative examples. Equivalent elements, or materials, processes or steps may be replaced with those representatively illustrated and described in the present disclosure. Expressions such as “including”, “comprising”, “incorporating”, “consisting of”, “have”, “is”, etc. used in describing the present disclosure should be interpreted in a non-exclusive manner, i.e., as allowing items, components or elements not explicitly stated to be displayed as well. Additionally, references to the singular shall be construed to include reference to the plural.

Furthermore, the exemplary embodiments included herein are to be regarded in an illustrative and illustrative sense, and should not be construed as limiting the content of the present disclosure. Any reference to joining (e.g., attached, affixed, coupled, connected, etc.) is used only to aid understanding of the present disclosure and are not intended to limit the location, orientation or use of the components or methods included herein. Accordingly, joining references, when present, should be interpreted broadly. Moreover, these joining references do not assume that two or more elements are directly connected to each other. Furthermore, any numeric term, such as “first”, “second”, “tertiary”, “primary”, “secondary”, “major” or any other general or numeric term is to be taken only as identifiers and to assist in the understanding of various elements, forms, variations or modifications of the present disclosure, and does not imply any limitation on any element, form, change or modification or order or preference thereof. That is, such expressions may be used to describe various components, but the components are not limited by these expressions. The expressions are used only for distinguishing one component from another.

Terms “module” and “unit” that are used for components in the following description are used only for the convenience of description without having discriminate meanings or functions.

It is to be understood that when one element is referred to as being “connected to” or “coupled to” another element, it may be directly connected to or directly coupled to another element or be connected to or coupled to another element, having the other element intervening therebetween. On the other hand, it should to be understood that when one element is referred to as being “directly connected to” or “directly coupled to” another element, it may be connected to or coupled to another element without the other element intervening therebetween.

A controller may include a communication device that communicates with another controller or a sensor to control corresponding functions, a memory that stores an operating system or logic commands and input/output information, and one or more processors that perform determination, calculation, decision, etc. For controlling the corresponding functions.

Any number or variety of components in any of the configurations described herein may be included within the present disclosure described herein. The components may include any combination of features described herein and may be disposed in any of the various configurations described herein. The concepts regarding the structure and arrangement of the components of the present disclosure, as well as the use and operation thereof, may be applied to any number of embodiments in any combination, not just the specific embodiments discussed herein. Embodiments including those including various features in various arrangements are described below with reference to the drawings.

Hereafter, the exemplary embodiments of the present disclosure will be described in detail with reference to the accompanying drawings, and identical or similar components are provided the same reference numerals regardless of the numbers in the drawings and redundant descriptions thereof will be omitted.

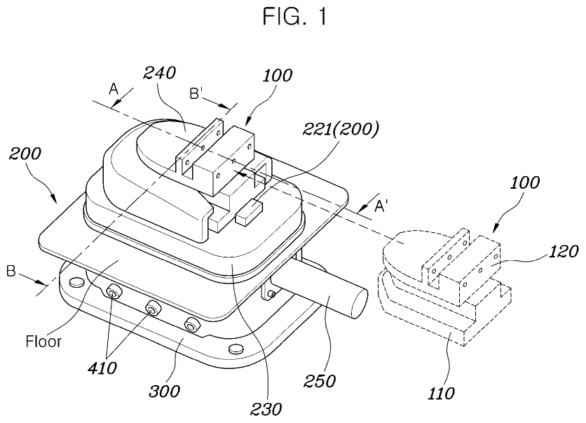

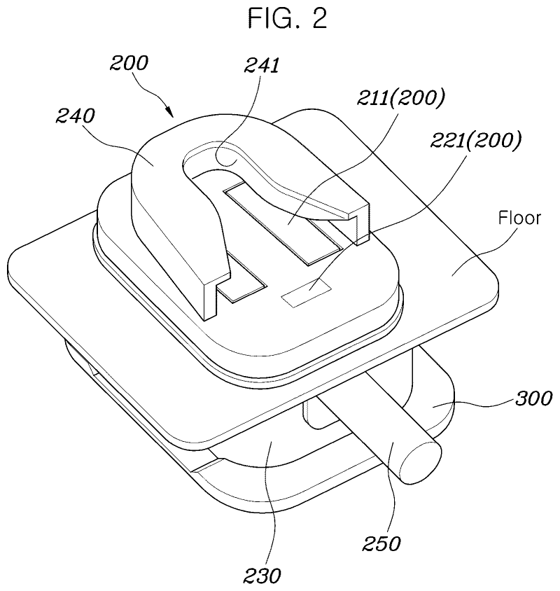

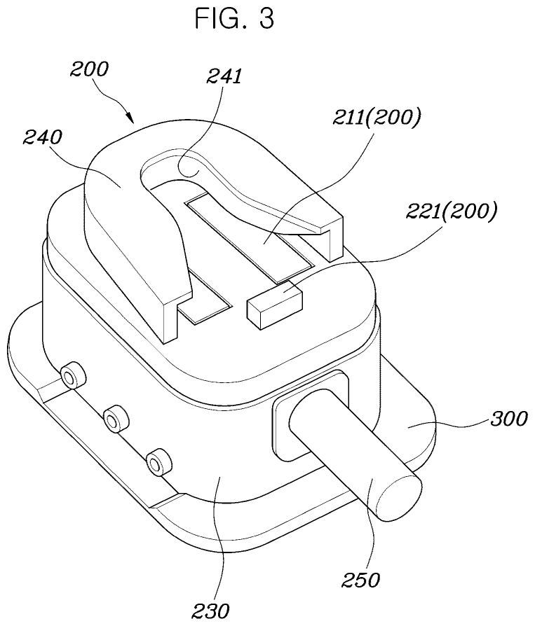

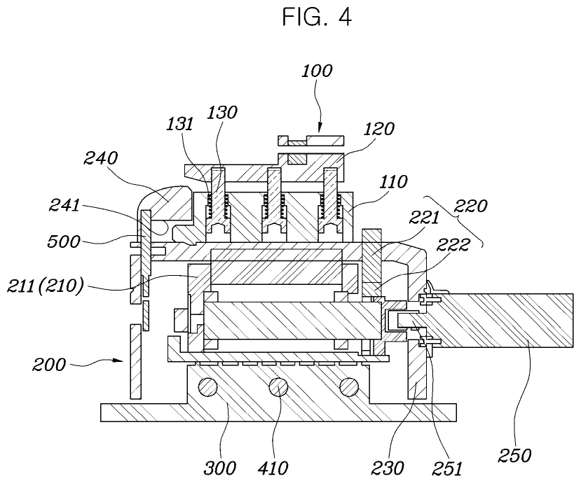

As shown in FIG. 1, FIG. 2, FIG. 3, and FIG. 4, a fixing device for personal mobilities according to an exemplary embodiment of the present disclosure includes: a connection module 100 provided to an object requiring fixation; and a fixing module 200 provided on the floor surface, into which a portion of the connection module 100 is inserted, and including a first fixing means 210 and a second fixing means 220 for fixing the inserted connection module 100, wherein the first fixing means 210 is magnetically fixed to the connection module 100 by generating a magnetic field and the second fixing means 220 comes into contact with the inserted connection module 100 to mechanically fix the connection module 100.

The connection module 100 is provided on an object requiring fixation, and in the instant case, the object may include a wheelchair, an electric wheelchair, a small mobility, etc.

In an exemplary embodiment of the present disclosure, it is assumed that the object requiring fixation is a wheelchair, and the floor surface on which the fixing module 200 is provided is assumed to be the floor of a vehicle.

The connection module 100 may be provided anywhere on the object requiring fixation, but the connection module 100 is provided at the bottom portion of the object in consideration of the object's center of gravity and the distance from the ground.

Furthermore, although the fixing module 200 may be provided anywhere in a space where fixation of the object is required, the fixing module 200 is provided to be exposed above from the floor.

In the present way, the fixing module 200 is provided on the floor of the vehicle, and a portion of the connection module 100 provided on the object is inserted into the inside of the fixing module 200 so that the object provided with the connection module 100 is fixed to the floor of the vehicle.

In an exemplary embodiment of the present disclosure, the connection module 100 provided on the object is fixed by the fixing module 200, and is firmly fixed to the fixing module 200 through magnetic fixation and mechanical fixation therebetween.

For the present purpose, the fixing module 200 includes the first fixing means 210 and the second fixing means 220. That is, the fixing module 200 is configured so that a portion of the connection module 100 is inserted therein, and when a portion of the connection module 100 is inserted, the first fixing means 210 secures the connection module 100 by generating a magnetic field, and the second fixing means 220 contacts with the connection module 100 to restrict movement, mechanically fixing the connection module 100. In the present way, the first fixing means 210 allows the connection module 100 to be magnetically connected through the creation of a magnetic field, and the second fixing means 220 contacts with the connection module 100 inserted into the fixing module 200 and forcibly restricts the movement of the connection module 100, so that the connection module 100 is mechanically connected and the position of the connection module 100 is fixed.

Below, the fixing device for personal mobilities according to an exemplary embodiment of the present disclosure will be described in detail.

As shown in FIGS. 2 and 4, the fixing module 200 may include: a housing 230 provided on the floor surface; and a fixing holder 240 with a guide groove 241 formed inward of the fixing holder 240 at the top portion of the housing 230.

Furthermore, the connection module 100 may include a fixing guide 110 whose insertion direction is guided along the guide groove 241 of the fixing holder 240.

Due to the provided configuration, the fixing guide 110 of the connection module 100 is inserted along the guide groove 241 formed on the inside of the fixing holder 240, and when the fixing guide 110 is completely inserted into the guide groove 241, movement thereof is limited inside the fixing holder 240.

The housing 230 may be provided to be buried in the floor at a location where the object is to be fixed, and a portion of the housing 230 may be exposed. The fixing holder 240 is provided on the housing 230, and the first fixing means 210 and the second fixing means 220 may be provided inside the housing 230. The housing 230 is configured to be airtight inside and outside thereof to prevent foreign substances or moisture from entering the interior where the first fixing means 210 and the second fixing means 220 are located.

The fixing holder 240 is provided to be exposed above the housing 230, and the guide groove 241 may be formed horizontally like the floor surface. In an exemplary embodiment of the present disclosure, the object on which the connection module 100 is provided may be a wheelchair, and as the wheelchair moves on the floor surface, the fixing guide 110 of the connection module 100 may be moved straight and inserted into the guide groove 241 of the fixing holder 240.

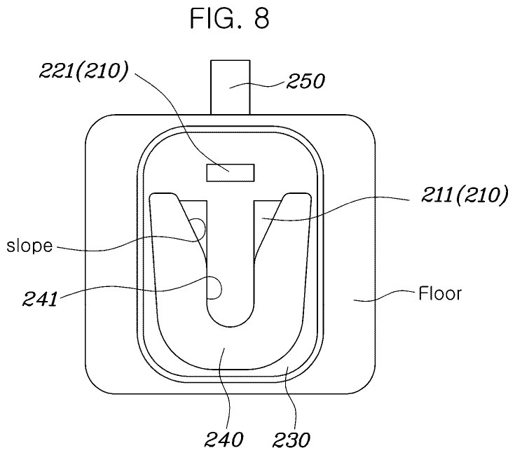

Furthermore, as shown in FIG. 8, the guide groove 241 of the fixing holder 240 may be formed to have an area that gradually narrows inwardly from the entrance portion thereof where insertion of the fixing guide 110 begins. Accordingly, the entrance portion of the fixing holder 240 may be formed in a V shape.

Due to the provided configuration, when the fixing guide 110 of the connection module 100 is inserted into the guide groove 241 of the fixing holder 240, the insertion direction of the fixing guide 110 will be guided by the shape of the entrance portion of the fixing holder 240. That is, when the fixing guide 110 enters the guide groove 241 of the fixing holder 240, the fixing guide 110 can pass through the wide entrance and smoothly enter the guide groove 241, and as the fixing guide 110 passes the point where the entrance of the fixing holder 240 gradually narrows, the position of the fixing guide 110 is aligned and the fixing guide 110 may move to the inside of the guide groove 241.

Thus, the portion of the fixing guide 110 inserted into the fixing holder 240 may be formed in a V shape to match the shape of the guide groove 241 of the fixing holder 240, and when the fixing guide 110 is inserted into the guide groove 241 of the fixing holder 240, the fixed state of the connection module 100 may be stabilized through shape matching.

Furthermore, the fixing holder 240 may be formed so that the upper end portion of the entrance portion thereof where insertion of the fixing guide 110 begins in the guide groove 241 is inclined downward.

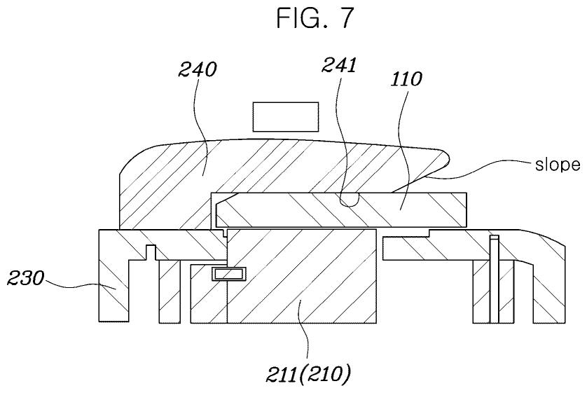

Referring to FIG. 7, as the fixing holder 240 is formed so that the upper end portion of the entrance portion in the guide groove 241 is inclined downward, when the fixing guide 110 enters the guide groove 241 of the fixing holder 240, the fixing guide 110 may be inserted into the guide groove 241 while sliding and moving downward along the slope formed in the fixing holder 240. Furthermore, the portion of the fixing guide 110 which is inserted into the fixing holder 240 is curved to minimize the contact area with the fixing holder 240 and is inserted into the guide groove 241 along the inclined surface of the fixing holder 240.

Accordingly, the guide groove 241 is formed in the fixing holder 240 of the fixing module 200 to insert the fixing guide 110 of the connection module 100, and due to the V-shape and inclined portion of the guide groove 241, the fixing guide 110 may be smoothly moved and inserted into the guide groove 241.

Meanwhile, the connection module 100 may further include a fixing bracket 120 for connection to the fixing guide 110.

The fixing bracket 120 is configured as an intermediate connector between the fixing guide 110 and the object, and may be formed as an integral portion of the object or configured to be strongly coupled to the object through bolt fastening.

Meanwhile, the fixing bracket 120 and the fixing guide 110 are connected to each other via a connection member 130 while spaced apart, and the connection member 130 may be elastically moved in the direction where the fixing bracket 120 and the fixing guide 110 face each other.

As shown in FIG. 4, the fixing bracket 120 and the fixing guide 110 are connected to each other through the connection member 130, and as the connection member 130 is configured to be elastically deformed or moved in the vertical direction in which the fixing bracket 120 and the fixing guide 110 face each other, the shock transmitted to the fixing bracket 120 may be absorbed by the connection member 130.

To be specific, the fixing holder 240 is formed with the upper portion thereof partially open, and when the fixing guide 110 of the connection module 100 is inserted into the guide groove 241 of the fixing holder 240, the connection member 130 may enter the open portion of the fixing holder 240.

Referring to FIG. 2, the fixing holder 240 is formed with the upper portion thereof partially open in the direction in which the guide groove 241 extends, so that the connection member 130 of the connection module 100 may be inserted into the open portion. Accordingly, when the connection module 100 is moved to be fixed to the fixing module 200, the fixing guide 110 of the connection module 100 is inserted into the guide groove 241 of the fixing holder 240, and as the connection member 130 of the connection module 100 is inserted into the upwardly open portion of the fixing holder 240, the connection module 100 may be inserted into and fixed to the fixing module 200.

Meanwhile, the connection member 130 includes an end portion coupled to the fixing bracket 120 and is provided to be movable in the vertical direction in the fixing guide 110, and may be elastically supported by an elastic body 131 within the fixing guide 110.

Referring to FIG. 4, the connection member 130 may be configured in a form of a bolt, one end portion of which may be fastened to the fixing bracket 120, and the other end portion may be provided to be movable in the vertical direction in the fixing guide 110. For the present purpose, a hole open in the vertical direction may be formed in the fixing guide 110, and the connection member 130 may be moved in the vertical direction through the hole. Additionally, the fixing guide 110 includes a jaw formed at the entrance of the hole to limit complete separation of the connection member 130.

Furthermore, the elastic body 131 is provided in the fixing guide, and the elastic body 131 is disposed to surround the external peripheral surface of the connection member 130. The elastic body 131 may include a spring, and the elastic body 131 elastically supports the connection member 130 from the fixing guide 110. Due to the provided configuration, the connection member 130 moves in the vertical direction within the fixing guide 110, and is elastically supported by the elastic body 131 to reduce the shock transmitted to the fixing bracket 120.

Furthermore, even if tolerance exists between the fixing guide 110 and the fixing holder 240 when the fixing guide 110 enters the guide groove 241 of the fixing holder 240, the tolerance between the fixing guide 110 and the fixing holder 24 is absorbed by the movement of the connection member 130, so that the fixing guide 110 may smoothly enter the guide groove 241 of the fixing holder 240.

A plurality of connection members 130 and the elastic bodies 131 may be provided between the fixing guide 110 and the fixing bracket 120.

Meanwhile, the fixing module 200 may further include a driving portion 250 which is provided in the housing 230 and generates rotation force, and as the first fixing means 210 and the second fixing means 220 are connected to the driving portion 250, magnetic fixation of the first fixing means 210 or mechanical fixation of the second fixing means 220 may be selectively switched. The driving portion 250 may include a motor.

Accordingly, in an exemplary embodiment of the present disclosure, the first fixing means 210 and the second fixing means are controlled by one driving portion 250, and by the driving portion 250, the magnetic fixation of the first fixing means 210 or mechanical fixation of the second fixing means 220 may be performed simultaneously or release of the fixation may be performed simultaneously. The driving portion 250 may be controlled by a controller, and the driving portion 250 may be operated according to a command signal from the controller.

The magnetic fixation of the first fixing means 210 according to the operation of the driving portion 250 will be described as follows.

The first fixing means 210 may include a pole portion 211, a first magnetic material 212, and a second magnetic material 213.

In the instant case, the pole portion 211 is provided inside the housing 230 and is partially exposed to the upper side of the housing 230 to contact with the fixing guide 110 inserted into the fixing holder 240. The first magnetic material 212 is rotatably provided on the pole portion 211 and is connected to the driving portion 250 to rotate, whereas the second magnetic material 213 is spaced apart from the first magnetic material 212 and fixed to the pole portion 211.

The pole portion 211 may be provided in a pair, and the first magnetic material 212 and the second magnetic material 213 may be provided between the pole portions 211. That is, a space in which the first magnetic material 212 and the second magnetic material 213 may be provided is formed between the pole portions 211, and as the first magnetic material 212 and the second magnetic material 213 are brought into contact with the pole portions 211, the pole portions 211 may be magnetized. The pole portions 211 are provided to be partially exposed to the upper side of the housing 230 to contact with the fixing guide 110 inserted into the fixing holder 240, and may be magnetized by the first magnetic material 212 and the second magnetic material 213 and magnetically coupled to the fixing guide 110.

The first magnetic material 212 and the second magnetic material 213 are made of permanent magnets, and the direction of magnetic flow may change depending on the rotational position of the first magnetic material 212 changed by the driving portion 250.

The fixing guide 110 and the pole portions 211 are made of magnetic material to form a magnetic flow, and the pole portions 211 may be magnetically coupled to and fixed to the fixing guide 110 due to the magnetic flow caused by the first magnetic material 212 and the second magnetic material 213 made of permanent magnets.

To be specific, the pole portions 211 and the fixing guide 110 may be made of magnetic material, and the first magnetic material 212 and the second magnetic material 213 are provided inside the pole portions 211 so that the pole portions 211 may be magnetized.

As an example of a method for manufacturing the pole portion 211 and the fixing guide 110 so that the pole portion 211 and the fixing guide 110 may be magnetically coupled, the metal powder forming the magnetic material is manufactured and mixed, the mixed powder is compression molded, and the compression molded pole portion 211 or the fixing guide 110 is heat treated to improve molding density and characteristics. At the instant time, the metal powder for manufacturing the pole portion 211 and the fixing guide 110 may be a Si—Fe alloy powder material. Because of this, it becomes possible to manufacture a magnetic material without containing rare earth elements in the magnetic material, making it possible to manufacture a magnetic material with improved magnetic force and corrosion resistance. Therefore, it is possible to manufacture a magnetic material with improved magnetic properties such as coercive force without compromising corrosion resistance.

As the first magnetic material 212 is connected to the driving portion 250 and rotated inside the pole portions 211, the directions of the N and S poles in contact with the pole portions 211 are switched. In the case of the second magnetic material 213, as the second magnetic material 213 is fixed to the pole portions 211, the positions of the N and S poles are fixed.

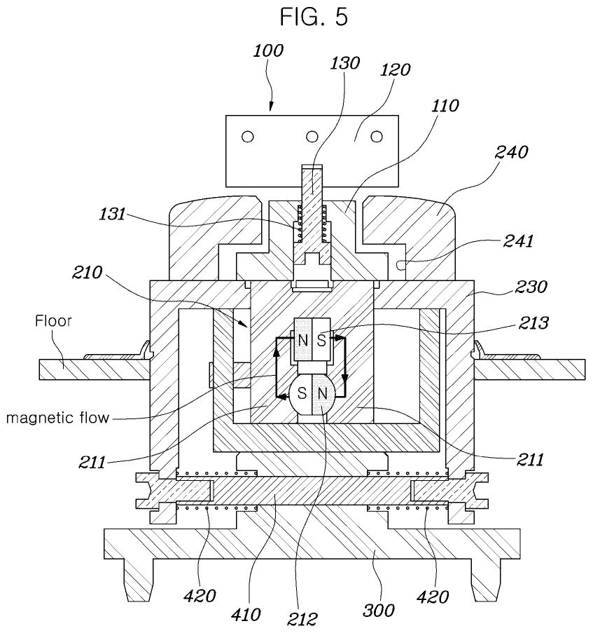

Due to the provided configuration, referring to FIG. 5, when the first magnetic material 212 is rotated by the driving portion 250 and disposed so that each polarity of the first magnetic material 212 intersects each polarity of the second magnetic material 213, a magnetic flow is generated only in the first magnetic material 212 and the second magnetic material 213 via the pole portions 211. Accordingly, the pole portions 211 may be in an unattached state even if the pole portions 211 contact with the fixing guide 110.

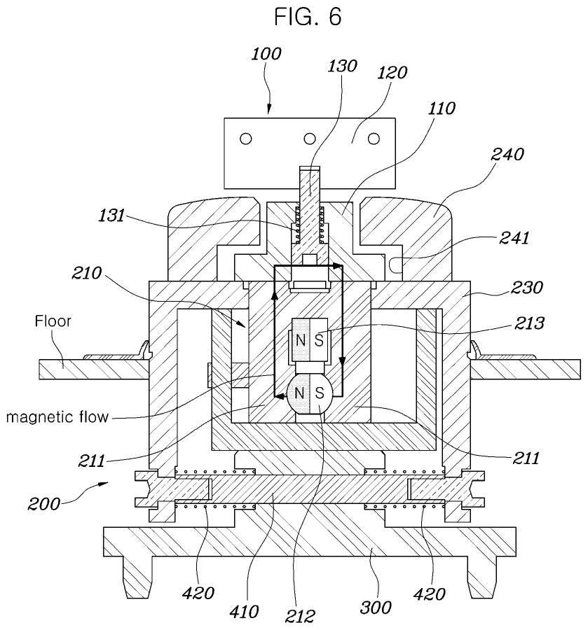

In the instant case, as shown in FIG. 6, when the first magnetic material 212 is rotated by the driving portion 250 so that polarities of the first magnetic material 212 match polarities of the second magnetic material 213, a magnetic field is formed in a direction to pass through the fixing guide 110 through the pole portions 211, and the pole portions 211 and the fixing guide 110 may be magnetically coupled.

In the present way, the coupling of the pole portions 211 and the fixing guide 110 by magnetic force may be performed by operating the driving portion 250 and changing the rotational position of the first magnetic material 212 by the driving portion 250. That is, in an exemplary embodiment of the present disclosure, the coupling state of the pole portion 211 and the fixing guide 110 may be switched by the first magnetic material 212 and the second magnetic material 213, and in a state where the polarities of the first magnetic material 212 and the second magnetic material 213 are matched, the coupling state is maintained even if the driving portion 250 is not driven, and thus power consumption for maintaining docking is reduced.

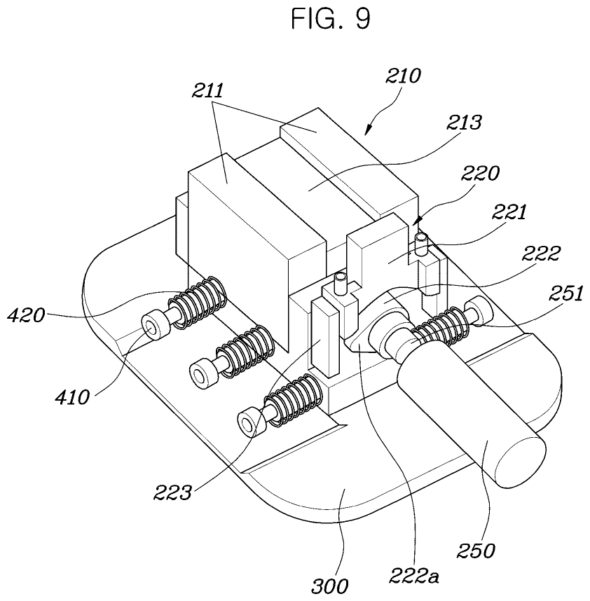

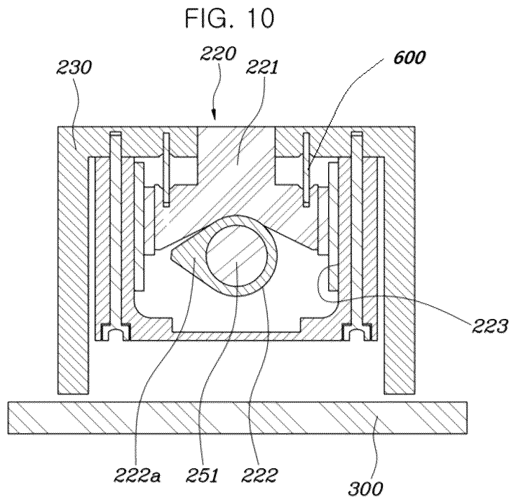

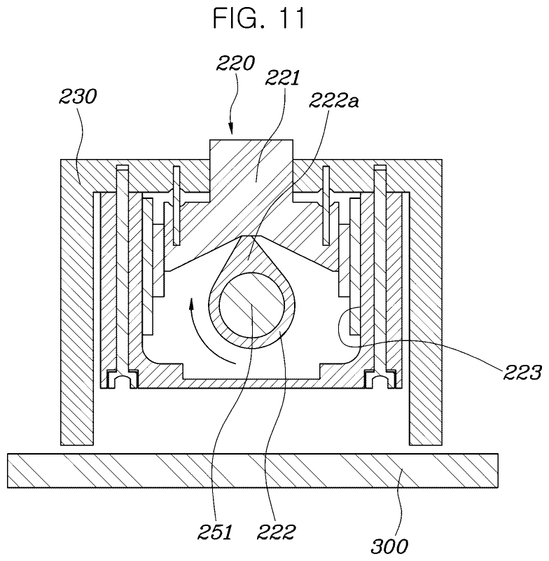

Meanwhile, as shown in FIGS. 9 to 11, the second fixing means 220 may include a fixing block 221 provided inside the housing 230, connected to the driving portion 250, and taken out to the upper side of the housing 230 according to the position changed by the driving portion 250.

The fixing block 221 is moved in the vertical direction by the driving portion 250. When the fixing block 221 is moved upward, the fixing block 221 is taken out to the upper side of the housing 230 and regulates the position of the fixing guide 110 inserted into the fixing holder 240, whereas when the fixing block 221 is moved downward, as the fixing block 221 is disposed into the housing 230, the fixing guide 110 may enter the fixing holder 240 or be separated from the fixing holder 240.

The fixing block 221 may limit the separation of the fixing guide 110 as the fixing block 221 is disposed to be taken out in the opposite direction of the insertion direction of the fixing guide 110 in a state where the fixing guide 110 is inserted into the fixing holder 240.

Referring to FIGS. 1 and 3, the fixing block 221 is provided to be taken out of the housing 230, and when the fixing block 221 is taken out while the fixing guide 110 is inserted into the fixing holder 240, the fixing block 221 is located on the opposite side of the insertion direction of the fixing guide 110, preventing the fixing guide 110 from being separated from the fixing holder 240. That is, assuming that the direction in which the fixing guide 110 enters the fixing holder 240 is forward, the fixing block may be taken out to contact with the rear end portion of the fixing guide 110 so that the fixing guide 110 is fixed.

To describe the fixing block 221 in detail, the second fixing means 220 may further include a cam portion 222.

The cam portion 222 includes an inclined portion 222a formed on the peripheral surface thereof and is connected to the driving portion 250 to rotate. In a state where the fixing block 221 is seated on the cam portion 222, the fixing block 221 may be taken out or put into the upper side of the housing 230 by making a linear reciprocating movement in the vertical direction by the rotation of the cam portion 222. An elastic member 600 between the housing 230 and the fixing block 221 may be disposed.

In the present way, the cam portion 222 includes the inclined portion 222a formed on a portion of the peripheral surface thereof, and the fixing block 221 is seated on the peripheral surface of the cam portion 222. The cam portion 222 is connected to the driving portion 250 to adjust the rotation position, and when the cam portion 222 is rotated and the inclined portion 222a comes into contact with the fixing block 221, the fixing block 221 is pushed by the inclined portion 222a and may be taken out through the upper side of the housing 230. Furthermore, the fixing block 221 may be maintained in a state of being put into the interior of the housing 230 when fixing block 221 contacts with the remaining peripheral surface of the cam portion 222 excluding the inclined portion 222a.

Meanwhile, the fixing block 221 is provided to be configured for linear movement in the housing 230. That is, the fixing block 221 is provided to be taken out through the housing 230 toward the fixing holder 240, and may be taken out of or put into the housing 230 as the fixing block 221 moves linearly in the direction through which the fixing block 221 is provided to penetrate the housing 230.

To the present end, the second fixing means 220 may further include a support portion 223 that guides the linear movement of the fixing block 221.

The support portion 223 is fixed inside the housing 230, accommodates the fixing block 221 inside, and may be provided to surround the outside of the fixing block 221. That is, the support portion 223 may be bolted and fixed inside the housing 230, and a space is formed inside the support portion 223, so that the fixing block 221 may be accommodated in the space. Additionally, a groove or protrusion may be formed on the internal surface of the support portion 223 to guide the linear movement of the fixing block 221, and a protrusion or groove connected to the groove or protrusion of the support portion 223 is formed on the external surface of the fixing block 221 to guide the linear movement of the fixing block 221.

Meanwhile, in an exemplary embodiment of the present disclosure, the fixed state of the first fixing means 210 and the second fixing means 220 may be switched using a single driving portion 250.

To be specific, the driving portion 250 is provided with a shaft 251 which is rotated by rotation force, and shaft 251 is connected to the first fixing means 210 and the second fixing means 220, so that when the shaft 251 rotates, magnetic fixation of the first fixing means 210 and mechanical fixation of the second fixing means 220 may be performed simultaneously.

To the present end, inside the housing 230, the driving portion 250, the first fixing means 210, and the second fixing means 220 are disposed in series, so that the shaft 251 of the driving portion 250 may be connected to the first fixing means 210 and the second fixing means 220.

Referring to FIG. 9, as the driving portion 250, the first fixing means 210, and the second fixing means 220 are disposed in series, one shaft 251 extending from the driving portion 250 may be connected to the first fixing means 210 and the second fixing means 220. Due to the provided configuration, when the driving portion 250 operates and the shaft 251 rotates, the first fixing means 210 and the second fixing means 220 are linked to the rotation of the shaft 251 and may be switched to the fixed or unlocked state at the same time.

In the instant case, the shaft 251 of the driving portion 250 may be connected, along the extending direction, to the cam portion 222 of the second fixing means 220 and the first magnetic material 212 of the first fixing means 210.

That is, as the shaft 251 is rotated by operation of the driving portion 250, the first magnetic material 212 of the first fixing means 210 is rotated so that the polarities of the first magnetic material 212 match the polarities of the second magnetic material 213, and the cam portion 222 of the second fixing means 220 may be rotated so that the inclined portion 222a may contact with the fixing block 221. Due to the provided configuration, the magnetic fixation of the first fixing means 210 and the mechanical fixation of the second fixing means 220 are performed simultaneously, so that the connection module 100 may be fixed to the fixing module 200.

Furthermore, as the shaft 251 is rotated by operation of the driving portion 250, when the first magnetic material 212 of the first fixing means 210 is rotated so that the polarities of the first magnetic material 212 do not match the polarities of the second magnetic material 213, and the cam portion 222 of the second fixing means 220 is rotated and the inclined portion 222a does not contact with the fixing block 221, the fixed state of the first fixing means 210 and the second fixing means 220 is released, and the connection module 100 may be separated from the fixing module 200.

Meanwhile, as shown in FIGS. 1, 4, and 9, a lower plate 300 is provided below the fixing module 200, and the lower plate 300 and the housing 230 are connected via a guide pin 410, allowing the housing 230 to move along the extension direction of the guide pin 410.

Furthermore, the guide pin 410 is provided with an elastic member 420 that provides elastic support between the lower plate 300 and the housing 230, so that the housing 230 may elastically move within the lower plate 300 along the guide pin 410 in the direction in which the guide pin 410 extends.

In the instant case, the guide pin 410 is provided to penetrate the housing 230 and the lower plate 300 in a direction perpendicular to the direction in which the fixing guide 110 of the connection module 100 is inserted into the fixing holder 240 to connect the housing 230 and the lower plate 300. Furthermore, the elastic member 420 is provided on the external peripheral surface of the guide pin 410, and may elastically support the housing 230 to reduce vibration transmitted to the housing 230.

A plurality of guide pins 410 and elastic members 420 may be provided and connected to the housing 230 and the lower plate 300.

Meanwhile, the fixing holder 240 is provided with a sensor 500 which is configured for measuring the distance from the fixing guide 110, and a controller which is configured to determine completion of insertion of the fixing guide 110 according to a sensing value of the sensor 500 may be further included.

The sensor 500 may be one of at least one laser, ultrasonic wave, etc., and various means of measuring the distance may be applied. The sensor 500 is provided in the fixing holder 240 and provided in the guide groove 241, and may measure the distance of the fixing guide 110 inserted into the guide groove 241.

Due to the provided configuration, the controller is configured to receive distance information of the fixing guide 110 inserted into the fixing holder 240 from the sensor 500, determine whether the fixing guide 110 is completely inserted into the fixing holder 240, and when the fixing guide 110 is completely inserted into the fixing holder 240, may transmit the corresponding command signal to the driving portion 250 to regulate the position of the fixing guide 110 by the first fixing means 210 and the second fixing means 220.

According to the fixing device for personal mobilities of the present disclosure, it is possible to secure small mobilities, including wheelchairs, to large mobilities, including vehicles, with strong fixing force, and ensure convenience of use by making it easy to fix or unlock small mobilities.

Furthermore, the term related to a control device such as “controller”, “control apparatus”, “control unit”, “control device”, “control module”, “control circuit”, or “server”, etc refers to a hardware device including a memory and a processor configured to execute one or more steps interpreted as an algorithm structure. The memory stores algorithm steps, and the processor executes the algorithm steps to perform one or more processes of a method in accordance with various exemplary embodiments of the present disclosure. The control device according to exemplary embodiments of the present disclosure may be implemented through a nonvolatile memory configured to store algorithms for controlling operation of various components of a vehicle or data about software commands for executing the algorithms, and a processor configured to perform operation to be described above using the data stored in the memory. The memory and the processor may be individual chips. Alternatively, the memory and the processor may be integrated in a single chip. The processor may be implemented as one or more processors. The processor may include various logic circuits and operation circuits, may be configured for processing data according to a program provided from the memory, and may be configured to generate a control signal according to the processing result.

The control device may be at least one microprocessor operated by a predetermined program which may include a series of commands for carrying out the method included in the aforementioned various exemplary embodiments of the present disclosure.

The aforementioned invention can also be embodied as computer readable codes on a computer readable recording medium. The computer readable recording medium is any data storage device that can store data which may be thereafter read by a computer system and store and execute program instructions which may be thereafter read by a computer system. Examples of the computer readable recording medium include Hard Disk Drive (HDD), solid state disk (SSD), Silicon Disk Drive (SDD), read-only memory (ROM), random-access memory (RAM), CD-ROMs, magnetic tapes, floppy discs, optical data storage devices, etc and implementation as carrier waves (e.g., transmission over the Internet). Examples of the program instruction include machine language code such as those generated by a compiler, as well as high-level language code which may be executed by a computer using an interpreter or the like. Furthermore, the non-transitory computer-readable recording medium may be distributed over computer systems connected through a network, and computer-readable program code may be stored and executed in a distributive manner.

In various exemplary embodiments of the present disclosure, each operation described above may be performed by a control device, and the control device may be configured by a plurality of control devices, or an integrated single control device.

In various exemplary embodiments of the present disclosure, the memory and the processor may be provided as one chip, or provided as separate chips.

In various exemplary embodiments of the present disclosure, the scope of the present disclosure includes software or machine-executable commands (e.g., an operating system, an application, firmware, a program, etc.) for enabling operations according to the methods of various embodiments to be executed on an apparatus or a computer, a non-transitory computer-readable medium including such software or commands stored thereon and executable on the apparatus or the computer.

In various exemplary embodiments of the present disclosure, the control device may be implemented in a form of hardware or software, or may be implemented in a combination of hardware and software.

Software implementations may include software components (or elements), object-oriented software components, class components, task components, processes, functions, attributes, procedures, subroutines, program code segments, drivers, firmware, microcode, data, database, data structures, tables, arrays, and variables. The software, data, and the like may be stored in memory and executed by a processor. The memory or processor may employ a variety of means well-known to a person including ordinary knowledge in the art.

Furthermore, the terms such as “unit”, “module”, etc. included in the specification mean units for processing at least one function or operation, which may be implemented by hardware, software, or a combination thereof.

Hereinafter, the fact that pieces of hardware are coupled operatively may include the fact that a direct and/or indirect connection between the pieces of hardware is established by wired and/or wirelessly.

In an exemplary embodiment of the present disclosure, the vehicle may be referred to as being based on a concept including various means of transportation. In some cases, the vehicle may be interpreted as being based on a concept including not only various means of land transportation, such as cars, motorcycles, trucks, and buses, that drive on roads but also various means of transportation such as airplanes, drones, ships, etc.

For convenience in explanation and accurate definition in the appended claims, the terms “upper”, “lower”, “inner”, “outer”, “up”, “down”, “upwards”, “downwards”, “front”, “rear”, “back”, “inside”, “outside”, “inwardly”, “outwardly”, “interior”, “exterior”, “internal”, “external”, “forwards”, and “backwards” are used to describe features of the exemplary embodiments with reference to the positions of such features as displayed in the figures. It will be further understood that the term “connect” or its derivatives refer both to direct and indirect connection.

The term “or” used in an exemplary embodiment of the present disclosure should be interpreted as indicating “additionally or alternatively.”

The term “and/or” may include a combination of a plurality of related listed items or any of a plurality of related listed items. For example, “A and/or B” includes all three cases such as “A”, “B”, and “A and B”.

In exemplary embodiments of the present disclosure, “at least one of A and B” may refer to “at least one of A or B” or “at least one of combinations of at least one of A and B”. Furthermore, “one or more of A and B” may refer to “one or more of A or B” or “one or more of combinations of one or more of A and B”.

In the present specification, unless stated otherwise, a singular expression includes a plural expression unless the context clearly indicates otherwise.

The terms used to describe the embodiments are used for describing specific embodiments, and are not intended to limit the embodiments. As used in the description of the embodiments and in the claims, the singular forms “a”, “an”, and “the” include plural referents unless the context clearly dictates otherwise. The expression “and/or” is used to include all possible combinations of terms.

In the exemplary embodiment of the present disclosure, it should be understood that a term such as “include” or “have” is directed to designate that the features, numbers, steps, operations, elements, parts, or combinations thereof described in the specification are present, and does not preclude the possibility of addition or presence of one or more other features, numbers, steps, operations, elements, parts, or combinations thereof.

As used herein, conditional expressions such as “if” and “when” are not limited to an optional case and are intended to be interpreted, when a specific condition is satisfied, to perform the related operation or interpret the related definition according to the specific condition.

Terms such as first and second may be used to describe various elements of the embodiments. However, various components according to the exemplary embodiments should not be limited by the above terms. These terms are only used to distinguish one element from another.

According to an exemplary embodiment of the present disclosure, components may be combined with each other to be implemented as one, or some components may be omitted.

The foregoing descriptions of specific exemplary embodiments of the present disclosure have been presented for purposes of illustration and description. They are not intended to be exhaustive or to limit the present disclosure to the precise forms disclosed, and obviously many modifications and variations are possible in light of the above teachings. The exemplary embodiments were chosen and described in order to explain certain principles of the invention and their practical application, to enable others skilled in the art to make and utilize various exemplary embodiments of the present disclosure, as well as various alternatives and modifications thereof. It is intended that the scope of the present disclosure be defined by the Claims appended hereto and their equivalents.

What is claimed is:

1. A fixing apparatus for personal mobilities, the fixing apparatus comprising:
a connection module provided to an object requiring fixation; and
a fixing module provided on a floor surface, into which a portion of the connection module is inserted, and including a first fixing means and a second fixing means for fixing the inserted connection module,
wherein the first fixing means is magnetically fixed to the connection module by generating a magnetic field and the second fixing means comes into contact with the inserted connection module to mechanically fix the connection module.

2. The fixing apparatus of claim 1,
wherein the fixing module includes:
a housing provided on the floor surface; and
a fixing holder including a guide groove formed inward of the fixing holder at a top portion of the housing, and
wherein the connection module includes a fixing guide whose insertion direction is guided along the guide groove of the fixing holder.

3. The fixing apparatus of claim 2, wherein the guide groove of the fixing holder has an area that narrows inwardly from an entrance portion thereof where insertion of the fixing guide begins.

4. The fixing apparatus of claim 2, wherein the fixing holder is formed so that an upper end portion of an entrance portion thereof where insertion of the fixing guide begins in the guide groove is inclined downward.

5. The fixing apparatus of claim 2,
wherein the connection module includes a fixing bracket for connection to the fixing guide, and
wherein the fixing bracket and the fixing guide are connected to each other via a connection member while spaced apart, and the connection member is elastically movable in a direction where the fixing bracket and the fixing guide face each other.

6. The fixing apparatus of claim 5,
wherein the fixing holder is formed with an upper portion thereof partially open, and based on that the fixing guide of the connection module is inserted into the guide groove of the fixing holder, the connection member enters the open upper portion of the fixing holder, and
wherein the connection member includes an end portion coupled to the fixing bracket, is provided to be movable in a vertical direction in the fixing guide, and is elastically supported by an elastic body within the fixing guide.

7. The fixing apparatus of claim 2,
wherein the fixing module further includes a driving portion provided in the housing and configured to generate rotation force, and
wherein based on that the first fixing means and the second fixing means are connected to the driving portion, magnetic fixation of the first fixing means or mechanical fixation of the second fixing means are selectively switched.

8. The fixing apparatus of claim 7,
wherein the first fixing means includes a pole portion, a first magnetic material, and a second magnetic material, and
wherein the pole portion is provided inside the housing and is partially exposed to an upper side of the housing to contact with the fixing guide inserted into the fixing holder, the first magnetic material is connected to the driving portion and rotates from the pole portion, and the second magnetic material is spaced apart from the first magnetic material and fixed to the pole portion.

9. The fixing apparatus of claim 8, wherein the first magnetic material and the second magnetic material are made of permanent magnets, and a direction of magnetic flow changes depending on a rotational position of the first magnetic material changed by the driving portion.

10. The fixing apparatus of claim 8, wherein the pole portion and the fixing guide are made of magnetic material, and are magnetically joined by the first magnetic material and the second magnetic material.

11. The fixing apparatus of claim 7, wherein the second fixing means includes a fixing block slidably provided inside the housing, and coupled to the driving portion to be taken out through an upper side of the housing according to a position of the fixing block changed by the driving portion.

12. The fixing apparatus of claim 11, wherein the fixing block is disposed to be taken out in an opposite direction of the insertion direction of the fixing guide with the fixing guide inserted into the fixing holder, for limiting a departure of the fixing guide.

13. The fixing apparatus of claim 11,
wherein the second fixing means further includes a cam portion, and
wherein the cam portion includes an inclined portion formed on a peripheral surface of the cam portion and is connected to the driving portion to rotate, and
wherein in a state where the fixing block is seated on the cam portion, the fixing block is taken out of or put into the upper side of the housing by making a linear reciprocating movement in a vertical direction due to a rotation of the cam portion.

14. The fixing apparatus of claim 13,
wherein the second fixing means further includes a support portion guiding the linear reciprocating movement of the fixing block, and
wherein the support portion is fixed inside the housing, accommodates the fixing block therein, and is provided to surround an outside of the fixing block.

15. The fixing apparatus of claim 7, wherein the driving portion includes a shaft which is rotated by rotation force, wherein the shaft is connected to the first fixing means and the second fixing means, so that based on that the shaft rotates, the magnetic fixation of the first fixing means and the mechanical fixation of the second fixing means are performed simultaneously.

16. The fixing apparatus of claim 15, wherein the driving portion, the first fixing means, and the second fixing means are disposed in series inside the housing, so that the shaft of the driving portion is connected to the first fixing means and the second fixing means.

17. The fixing apparatus of claim 2,
wherein a lower plate is provided below the fixing module,
wherein the lower plate and the housing are connected via a guide pin, allowing the housing to move along an extension direction of the guide pin, and
wherein the guide pin is provided with an elastic member that provides elastic support between the lower plate and the housing.

18. The fixing apparatus of claim 2,
wherein the fixing holder is provided with a sensor configured for measuring a distance from the fixing guide, and
wherein the fixing apparatus further includes a controller which is configured to determine completion of insertion of the fixing guide according to a sensing value of the sensor.
